(19) United States
(12) Patent Application Publication
(10) Pub. No.: US 2009/0221307 A1
(43) Pub. Date: Sep. 3, 2009

(54) GROUP COMMUNICATIONS

(75) Inventors: Stephen Wolak, Newbury (GB); Peter Thompson, Bath (GB)

Correspondence Address: Workman Nydegger;1000 Eagle Gate Tower, 60 East South Temple, Salt Lake City, UT, 84111, US

(73) Assignee: VODAFONE GROUP PLC, Newbury, Berkshire (GB)

(21) Appl. No.: 12/066,789

(22) PCT Filed: Sep. 5, 2006
(86) PCT No.: PCT/GB2006/003276

§ 371 Date: Dec. 8, 2008

(30) Foreign Application Priority Data
Sep. 13, 2005 (GB) 0518679.6

(51) Int. Cl. H04W 4/12; G06F 15/16

(52) U.S. Cl. 455/466; 709/204

(57) ABSTRACT

The communications system is disclosed that includes a plurality of devices associated in a group. A server (50) administers communications between members of the group. Preferably, member devices of the group are provided with a client application (52) for communicating with the server (50). In the embodiment the client application is installed on a mobile or cellular telecommunications device, such as a GPRS or 3G mobile handset. The client facilitates communications of the user of the handset with the server, and provides an interface between the underlying device functionality (such as a built-in camera, the device's file system etc.) to allow content to be easily accessed and shared amongst members of the group. Communications between the client application and the server may be performed by XML over HTTP using a GPRS or 3G bearer.

### FIELD OF THE INVENTION

The invention relates to a telecommunications system including a plurality of devices associated in a group and a method of associating a plurality of communication devices in a group.

### BACKGROUND ART

WO-A-02/096056 and WO-A-2004/066554 relate to the formation of groups of users in a mobile telecommunications network.

The article, “What is IRC?” [online] January 2005, available from: http://web.archive.org/web/20040630224045/mirc.com/irc.html, and WO-A-2003/034672 A1 discuss Internet Relay Chat (IRC). IRC requires a proposed new member of a group to have a special client application on their terminal before they can successfully be invited to join the group.

### SUMMARY OF THE INVENTION

According to a first aspect of the present invention, there is provided a communications system, including a plurality of devices associated in a group, and a server for administering communications between members of the group, wherein each of said devices is provided with a client application for communicating with the server.

In one embodiment, data, including updates to the client application, contact information for users of the group or content for sharing between devices, is uploaded to the client application under control of the server. In the embodiment, the client application is uploaded to the devices under control of the server. The server is operable to modify the client application and/or said data in accordance with parameters associated with each device.

Because the client application may be uploaded to the devices under control of the server, in the embodiment, this allows a member of the group to enter the mobile telephone number of a user who they wish to join the group and that user is automatically sent a link via SMS to their mobile device to download and install their own “customised” version of the client application that is dynamically configured/built “on-the-fly” by the server. Therefore, a proposed member of the group can join the group without requiring a pre-loaded application to already be present on their device—in contrast to IRC, discussed above.

According to a second aspect of the present invention, there is provided a method of associating a plurality of communication devices in a group, the method including providing a server for administering communications between members of the group, and providing each of the devices with a client application for communicating with the server.

### BRIEF DESCRIPTION OF THE DRAWINGS

For better understanding of the present invention, a communications system and method embodying the invention will now be described by way of example only, with reference to the accompanying drawings, in which:—

FIG. 1 shows schematically the elements of a communications network, including a cellular or mobile telecommunications network;

FIG. 2 shows the client-server architecture of the embodiment;

FIG. 3 shows the logical entities of the client application;

FIG. 4 shows the logical entities of the server;

FIG. 5 shows the data exchanges between elements to create a community or group in accordance with the embodiment;

FIG. 6 shows the data exchanges taking place between elements to provide the client application to a device;

FIG. 7 shows the data exchanges taking place between elements when a user wishes to join a community or group;

FIG. 8 shows the data exchanges between elements taking place to share content within a community or group;

FIG. 9 shows how content is adapted or tailored to suit the devices of respective members of the community or group;

FIG. 10 shows the data exchanges taking place between elements to update the content of a community or group;

FIG. 11 shows the data exchanges taking place between elements to support multiple devices of a single user; and

FIG. 12 shows the data exchanges taking place between elements to share contact information between members of the group.

In the figures like elements are generally designated with the same reference sign.

### DETAILED DESCRIPTION OF EMBODIMENTS OF THE INVENTION

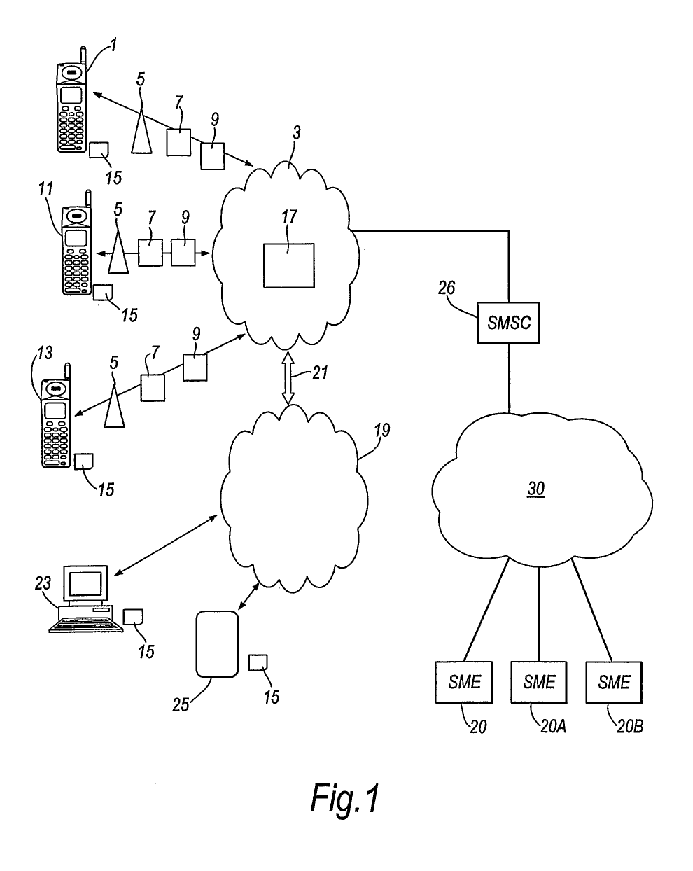

FIG. 1 shows schematically a network in which the invention may be used. The figure shows a mobile or cellular telecommunications network. However, it should be appreciated that the invention is applicable to any type of network, although it is particularly applicable to a network where at least some of the devices communicate using mobile telecommunications/wireless data transmission. Mobile terminal 1 is registered with GSM/GPRS or UMTS (3G) mobile telecommunications network 3. The mobile terminal 1 may be a handheld mobile telephone, a personal digital assistant (PDA) or a laptop computer equipped with a datacard. The mobile terminal 1 communicates wirelessly with mobile telecommunications network 3 via the radio access network (RAN) of the mobile telecommunications network 3, comprising, in the case of a UMTS network, base station (Node B) 5, and radio network controller (RNC) 7. Communications between the mobile terminal 1 and the mobile telecommunications network 3 are routed from the radio access network via GPRS support nodes (SGSN) 9, which may be connected by a fixed (cable) link to the mobile telecommunications network 3.

In the conventional manner, a multiplicity of other mobile terminals are registered with the mobile telecommunications network 3. These mobile terminals include mobile terminals 11 and 13. The terminals 11 and 13 communicate with the mobile telecommunications network 3 in a similar manner to the terminal 1, that is via an appropriate Node B 5, RNC 7 and SGSN 9.

The mobile telecommunications network 3 includes a gateway GPRS support node (GGSN) 17 which enables IP-based communications with other networks, such as the Internet 19 via an appropriate link 21. A multiplicity of terminals are connected to the Internet (by fixed or wireless links), and a PC terminal 23 and a PDA terminal 25 are shown by way of example.

Each of the mobile terminals 1,11 and 13 is provided with a respective subscriber identity module (SIM) 15. During the manufacturing process of each SIM, authentication information is stored thereon under the control of the mobile telecommunications network 3. The mobile telecommunications network 3 itself stores details of each of the SIMs issued under its control. In operation of the mobile telecommunications network 3, a terminal 1, 11, 13 is authenticated (for example, when the user activates the terminal in the network with a view to making or receiving calls) by the network sending a challenge to the terminal 1,11,13 incorporating a SIM 15, in response to which the SIM 15 calculates a reply (dependent on the predetermined information held on the SIM—typically an authentication algorithm and a unique key Ki) and transmits it back to the mobile telecommunications network 3. The mobile telecommunications network 3 includes an authentication processor 17 which generates the challenge and which receives the reply from the terminal 1,11,13. Using information pre-stored concerning the content of the relevant SIM 15, the authentication processor calculates the expected value of the reply from the mobile terminal 1,11,13. If the reply received matches the expected calculated reply, the SIM 15 and the associated mobile terminal are considered to be authenticated.

It should be understood that such an authentication process can be performed for any terminal provided with a SIM 15 under control of the mobile telecommunications network 3. In the embodiment the terminal communicates wirelessly with the mobile telecommunications network 3 via the network's radio access network, although this is not essential. For example, the terminal may communicate with the network via the fixed telephone network (PSTN), via a UMA “access point” and/or via the Internet. The PC 23 and the PDA 25 may also be provided with a SIM 15 under the control of the network.

The SIM 15 used by the terminal 1,11,13,23,25 may be a SIM of the type defined in the GSM or UMTS standards specifications, or may be a simulation of a SIM—that is, software or hardware that performs a function corresponding to that of the SIM. The SIM may be in accordance with the arrangement described in WO-A-2004 036513.

It should be noted that the authentication process being described does not necessarily authenticate the human identity of the user. For example, mobile telecommunication networks have pre-pay subscribers who are issued with SIMs in return for pre-payment, enabling them to use network services. However, the identity of such pre-pay subscribers may not be known by the network. Nevertheless, such a user cannot make use of the network until the network has authenticated the user's SIM—that is, has confirmed that such user is a particular user who has a particular pre-paid account with a network.

The network shown in FIG. 1 comprises both the mobile telecommunications network 3 and the Internet 19 (which itself comprises a multiplicity of other networks).

The procedure for transmission of “short messages” is different. The term “short messages” or “SMS messages” as used in relation to the embodiments means short messages as defined in the GSM or 3G standard specifications. Such messages are commonly in the form of text messages of limited maximum length, but they can have other forms, such as in the form of binary data, or may contain configuration data for changing the functional parameters of a mobile.

Short messages may be sent to or from mobiles such as the mobiles 1, 11, 13 and the others belonging to the network 3. However, in addition, short messages may be sent to or from “short message entities” (SMEs) such as shown at 20,20A,20B. These SMEs may be in the form of terminals of various sorts such as fixed terminals for sending short messages of various types to mobiles and for receiving short messages from mobiles. For example, the SMEs may be in the form of terminals associated with banking computers or computers of other types generating information (commercial information, for example) for transmission to mobiles and for receiving short messages in response from mobiles, but may be of many other types, such as application servers of various types.

The network 3 has a short message service centre (SMSC) 26 associated with it. The SMEs 20,20A,20B are connected to the SMSC 26 by fixed networks 30 of suitable type. When a mobile wishes to send a short message, it will do this via the SMSC 26 of its network 3. Thus, for example, if the mobile 1 wishes to send a short message to mobile 11, the short message is automatically addressed by the mobile 11 to SMSC 26, which then delivers the short message to mobile 11 (after registering the necessary details to enable a charge to be made to mobile 1). Each short message therefore carries the address of the local SMSC (this address is automatically generated by the sender), together with the address of the intended destination of the short message. When the local SMSC receives the short message, it then reads the address (the MSISDN or Mobile Station ISDN number or telephone number of the intended destination) and despatches the short message accordingly.

The embodiment now to be described in more detail enables users of communications devices (hereinafter “user devices”) to associate themselves in communities or groups. When a community has been established, the sharing of content between the community members is facilitated, in addition to other functions.

Each user device that is a member of any community preferably has a special “smart” client application installed thereon. The smart client is, in the embodiment, a Java or a C++ based smart client running on the user device and providing seamless integration and a consistent “look and feel” for a range of groups or “communities” of which the user of the user device is a member. The smart client allows particular services or functions to be accessed simply with a minimal number of key presses. The client provides access to user device functionality. For example, if the user device is a mobile telecommunications handset, such functionality might include a built-in camera, the device's file system and its Bluetooth connectivity. This allows content, location information and other information to be easily accessed and shared amongst members of a community.

A server administrates one or more communities. The server is an Internet-hosted system with direct connection to a number of communications gateways, such as SMS and MMS gateways. The server contains various logical entities, to be described in more detail below, that allow incoming client requests to be received and processed, and which carry out specific tasks for members of respective communities, such as formatting and distributing content to all the users in a particular community.

The server system provides a Java Servlet based interface that handles the sending and receiving of information from the smart client using a specifically defined XML schema. A web of the XHTML based portal allows users to create and maintain a variety of communities.

A context broker is a server entity that can be used to gather context information from a variety of different devices (e.g. all users within a particular community—information such as their location, presence etc.) and provide it to other devices in a controlled and secure manner.

In the server system an intelligent content handling mechanism delivers and where necessary adapts content and messages for delivery to community users in the most appropriate manner based on, for example, user profiles, context broker information, the content itself (size, type etc.) and perhaps a restriction on the time that the content can be distributed (for example, a release date in the future may be specified). Content and devices may be adapted in accordance with the arrangement described in GB-A-2403382 (“Secure Time”)—incorporated herein by reference—to control the time of consumption of content.

Preferably, communication between the server and the user device is via an “always on” GPRS or 3G data connection. If such a data connection is not available, communication may be by SMS. However, it should be understood that the user devices are not necessarily mobile telecommunications devices, but might instead be a personal computer (PC). Communications between the server and the computer may be performed via the fixed Internet, for example by using email messages or through a conventional web browser.

### Client-Server Architecture

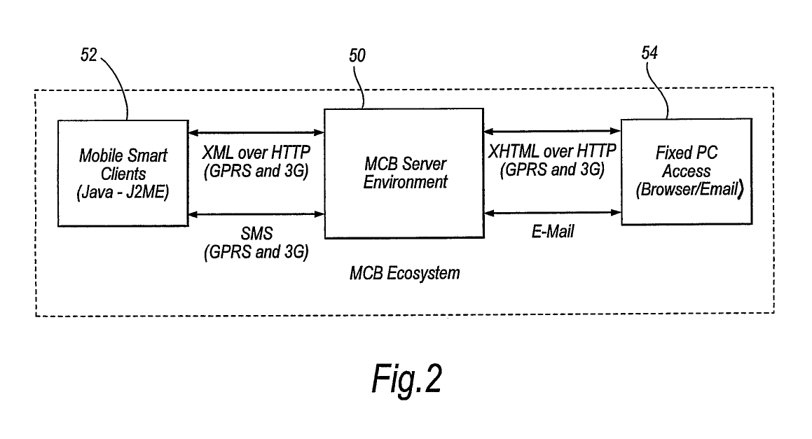

FIG. 2 shows schematically the basic client-server architecture. As indicated above, the server is an Internet-hosted system. The client application 52 of a first user device, comprising a cellular or mobile telecommunications device is shown. As indicated, communications between the server 50 and the client 52 may use XML over HTTP protocol by means of a GPRS or 3G bearer. Additionally, the communication may be by SMS message. Other communication frameworks may be used, such as IMS through the inclusion of SIP stacks (this would allow peer-to-peer communications between devices in the same community).

A client application 54 of a fixed PC is also shown. Communication between the server 50 and the client application of the fixed PC 54 may be by XHTML over HTTP protocol by means of a GPRS or 3G bearer, or by email.

### Client Logical Entities

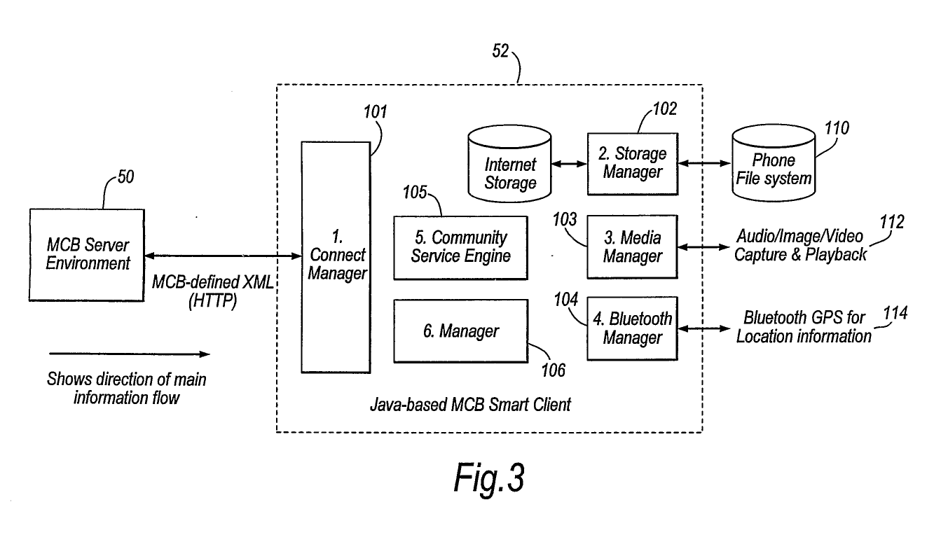

The client 52 is shown in more detail in FIG. 3. The client 52 consists of a number of logical entities:—
101. Connection Manager—this handles the sending, receiving and parsing of information (such as messages and content from the client and community service updates) via a specifically defined XML schema (the connection manager 101 is multi-threaded to handle the sending and receiving of information from the server 50 as a background process allowing the user full control over the user interface during this time). The XML schema has its own unique structure. An example schema is provided at the end of the description.
102. Storage Manager—handles the storage and retrieval of information from the client's internal storage (used to contain a local copy of a user's community information to provide an improved user experience) as well as the user device's internal file system 110 (the user can browser content stored external to the client on their phone for sharing with the community).
103. Media Manager—handles the interface to the user device's internal multimedia capabilities 112 (e.g. camera/microphone/speaker) for capturing and playing back community content.
104. Bluetooth Manager—handles the connection to an external Bluetooth GPS module 114 for obtaining a user's current location (used to share location information with other community members or location-tagging shared content if the user permits this).
105. Community Service Engine—handles all the internal community service logic for the client including the definition of all the services supported by each community.
106. UI Manager—handles the User Interface between the client 52 and user including the rendering of a Graphical User Community Interface (GUCI) to allow users to easily navigate between community environments and use specific services within these environments.

### Server Logical Entities

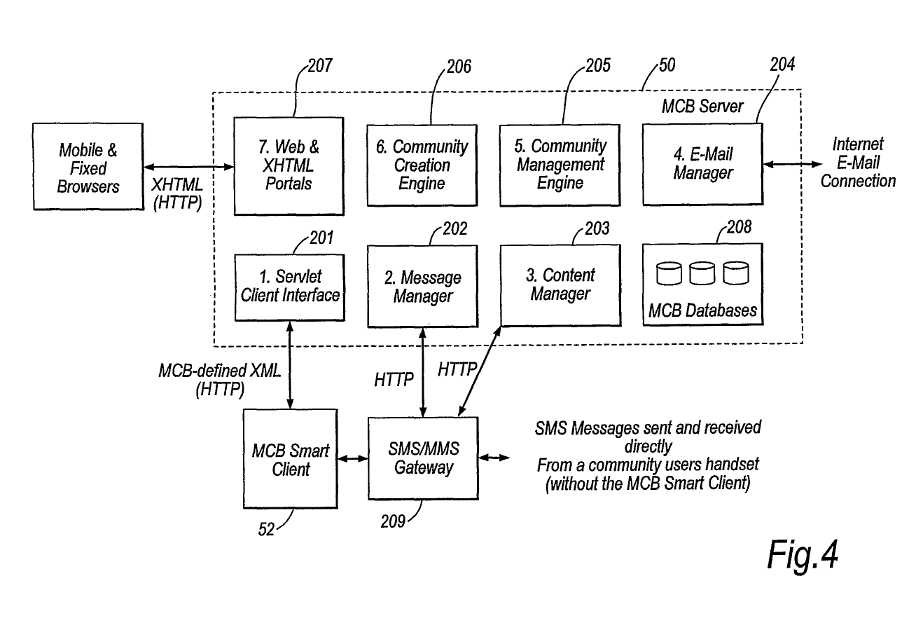

The server 50 is shown in more detail in FIG. 4. The server 50 consists of a number of logical entities:—
201. Servlet Client Interface—this entity consists of a number of Java Servlet components that act as an interface between the smart client 52 and the server 50. These Servlets effectively act as listeners for incoming client requests and are used to transfer information between client and server using a defined XML schema over HTTP.
202. Message Manager—handles the sending and receiving of SMS, WAP Push, and E-Mail messages through a connection to an SMS/MMS Gateway 209 and the internal E-Mail Manager 204. The message manager 202 also generates specially formatted ‘Java-Push-download’ messages that are used to trigger specific actions within the smart client.
203. Content Manager—handles the sending and receiving of content (images, audio, video etc.) between the server 50 and client 52 through connection to an SMS/MMS Gateway 209 and the internal E-Mail Manager 204. The content manager 203 can also be used to dynamically reformat and re-size content as necessary.
204. E-Mail Manager—handles the sending and receiving of emails between the MCB server and the external Internet.
205. Community Management Engine—this entity is used to manage the day-to-day functions of the server 50 and includes components such as a Registration Manager, Content Sharing Manager and Update Manager to be described in more detail later.
206. Community Creation Engine—this is used to generate/update clients 52 and their Servlet interfaces based on requests from users through the web, SMS and Smart Client Interfaces for new/updated community services and features. These dynamically generated clients 52 can be pushed to community users via WAP Push using the MessageManager 202.
207. Web and XHTML Portals—these portals provide a fixed and mobile web interface to the server 50 to allow users to manage their community environments.
208. Databases—various databases storing data relating to communities.

### Creating a Community

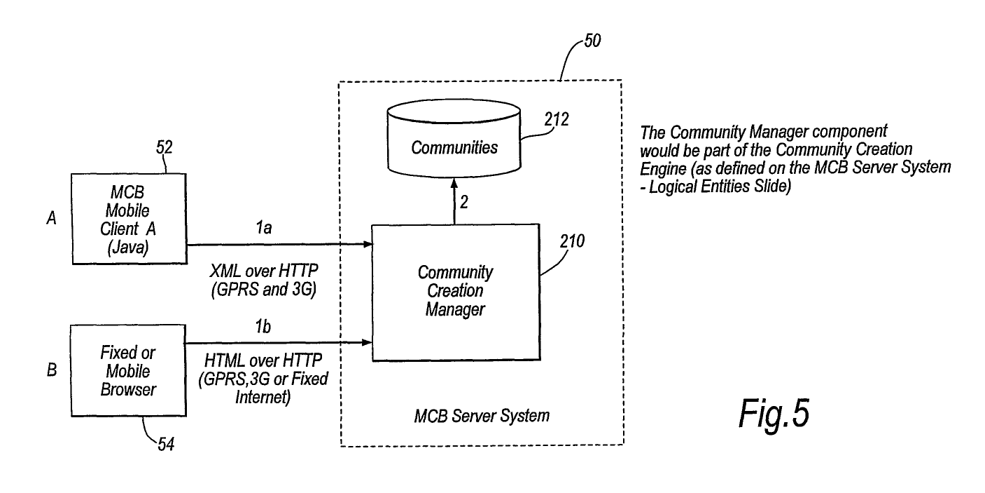

The procedure for creating a community will now be described with reference to FIG. 5. FIG. 5 shows a community creation manager 210, which is part of the community creation engine 206 of the server shown in FIG. 4. The community creation manager 210 is configured to communicate with the communities database 212, which forms part of the server databases 208. Initially, it will be assumed that the client application is already installed on the user's device (a procedure for a user obtaining the client application will be described later).

If the user device comprises a mobile telecommunications device 1, the user accesses the “create community” function on the client application 52 stored on the mobile telecommunications device. The GUI guides the user through a series of prompts and questions to define the type of community they wish to create (this information can be changed or updated at a later date).

The create community request is sent from the client application 52 to the community creation manager 210 in the server 50 via a predetermined XML schema (message 1a) by means of a packet-switched data connection using a GPRS or 3G bearer. The new community information is added to the communities database 212.

If the user's device does not have the client application 52 installed thereon, and the user cannot, or does not wish to, install the client 52, the user can create a community by accessing a “create community” website via a mobile or fixed browser on their device. The user is then guided through a set of intuitive web pages to define the type of community they wish to create (this information too can be changed or updated at a later date). The create community request is sent to the community creation manager 210, which hosts the “create community” web pages (message 1b). The new community information is added to the community's database 212 within the server 50 (message 2).

### Obtaining Client Application

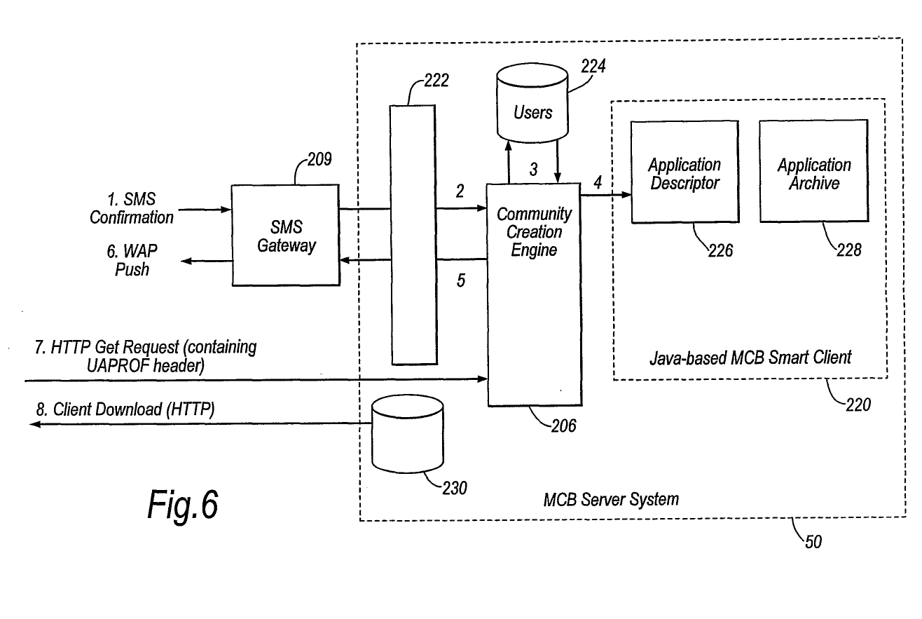

It will now be described with reference to FIG. 6 how a user device can obtain the client application 52. This operation is controlled by the community creation engine 206 in the server. A generic and “un-configured” client 220 is hosted on the server 50. For example, if a user device is a mobile telecommunications device, that user generates an SMS message requesting the client application (message 1). The SMS message is received by SMS gateway 209. The SMS gateway 209 determines the user's telephone number and adds this to the registration request. The registration request is passed to a registration servlet 222, that in turn passes the registration request to the community creation engine 206 (message 2). The community creation engine 206 then creates a new registration in the database 224 of users. The database 224 of users returns to the community creation engine 206 a new user ID that is assigned to this user (messages 3). The database of users 224 is one of the databases 208 of the server shown in FIG. 4.

In message 4, the community creation engine 206 then generates an application descriptor file 226 for the requested client, which contains a variety of user-specific parameters, including the assigned user ID. The application archive 228 may be rebuilt if necessary. The application archive is the actual client application that is compressed into a single file for installation on a mobile device—e.g. for Mobile Java this would be a JAR, Java Archive File

The community creation engine 206 then generates a WAP push message for the user device, which contains a URL to the client 220. The WAP push message is sent to the SMS gateway 209 via the registration servlet 222 (message 5). The SMS gateway 209 in turn sends the WAP push message to the user device (message 6).

When the user of the user device clicks on the URL contained in the WAP push message, the user's mobile communications device generates an HTTP GET request that will contain a UAPROF header (generated from the mobile terminal's internal browser)—message 7. The message will contain details of the type of mobile device (the make and model). The message is sent by means of a packet-switched data connection using a GPRS or 3G bearer. This data can be used to help dynamically configure the client 220 on the server 50 before the client 220 is downloaded. For example, this information might optimise the client application for the technical properties of the user device such as display characteristics (such as screen size parameters).

The client 220 is then downloaded directly from the server file system 230 to the user's device (message 8).

### Joining a Community

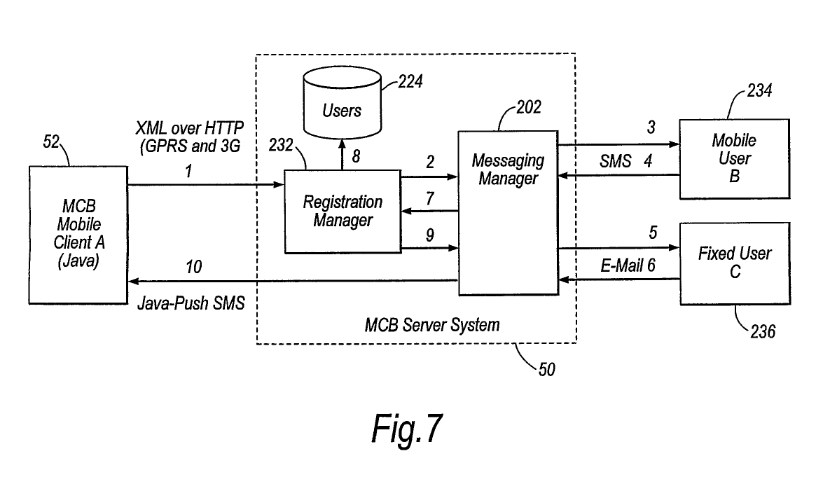

It will now be described with reference to FIG. 7 the procedure when a user A uses their mobile telecommunications device, with smart client installed thereon, to invite two friends to join (in this example) a golf community. The user A activates the client application 52 on the device and selects the two friends to join the golf community, for example, using the device's phone book. In this example, the first friend is a mobile telecommunications device 234 user B and the second friend is a user C of a fixed device 236 that has no mobile access and is a PC with an email address.

The client 52 sends registration information in a predetermined XML schema to the registration manager 232, forming part of the community management engine 205 of the server 50, message 1 by means of a packet-switched data connection using a GPRS or 3G bearer. The registration manager 232 then generates a request to the messaging manager 202 to send an invite message to the first friend (mobile user B) via SMS and to the second friend (fixed user C) via email (message 2). Accordingly, the messaging manager 202 sends an SMS manage inviting user B to join user A's golf community (message 3). When the message is received by the device of user B, user B is prompted to respond with a message confirming that they wish to join the community (message 4). Optionally, message 3 may include a WAP push link to allow user B to download the smart client application if they require an enhanced level of functionality. The smart client application, including special features for the particular community, will be dynamically be built in the server 50 and transmitted to user B in the manner described in relation to FIG. 6.

With regard to fixed user C, the messaging manager 202 sends an email inviting user C to join the community (message 5). User C then confirms that they wish to join the community (message 6).

The messaging manager 202 processes the reply messages (messages 4 and 6) and confirms the community join request to the registration manager 232 (message 7). The registration manager 232 stores the new registrations in the database 224 of users (message 8).

The registration manager 232 then instructs the messaging manager 202 to send a Java-push confirmation message to the mobile user A that user B and user C have joined the golf community (message 9). The messaging manager 202 then sends a Java-push confirmation message which causes the client application 52 on user A's device 1 to alert the user regarding the status of the new registrations (message 10).

Sharing Content with a Community

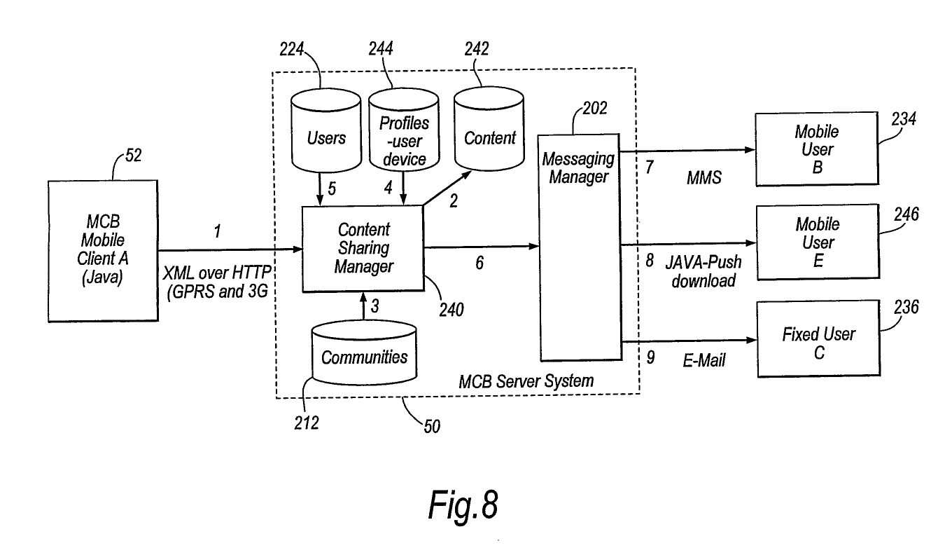

The procedure for sharing content amongst members of a community will now be described with reference to FIG. 8. By way of example, the procedure will be described when the user A of a mobile device including smart client 52 captures an image using the built-in camera of the device. When the image has been captured, the client application 52 on the device is then accessed and the option to “share” the image amongst members of the golf community is selected.

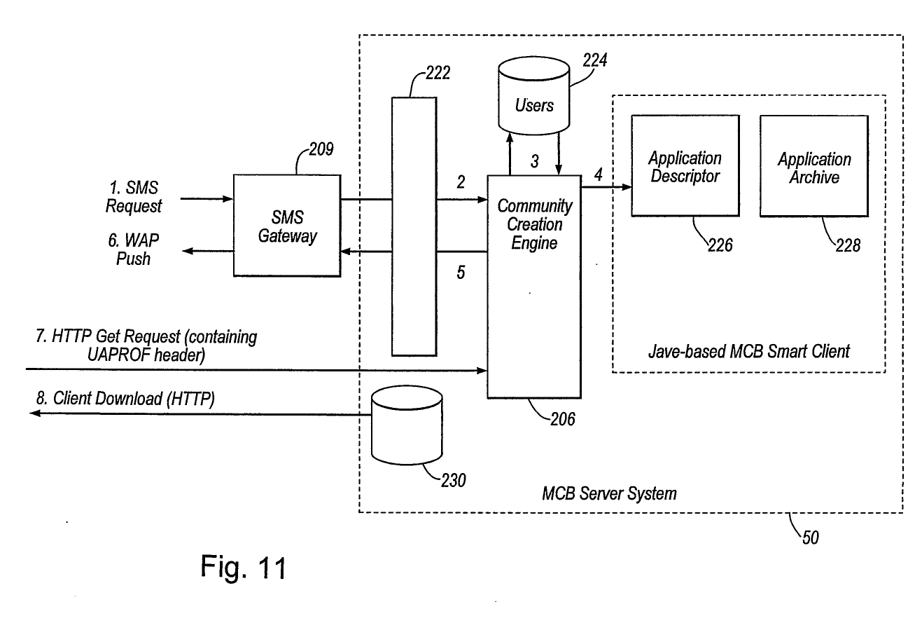

The client application 52 on the device passes the content sharing request to the content sharing manager 240, which forms part of the community management engine 205 function of the server 50—message 1. The content sharing request is transmitted using a predetermined XML schema over HTTP by means of a packet-switched data connection using a GPRS or 3G bearer. The content sharing manager 240 parses the request and stores the content in the content database 242, which comprises one of the databases 208 of the server 50 (FIG. 4), message 2. The content sharing manager 240 examines the communities database 212 to retrieve a list of user ID's of the members of the relevant community (the golf community in this example)—message 3. The content manager 240 then checks the user profiles database 244 to determine each user's preferences for how they would like to receive content (message 4). The user and device profiles database 244 is one of the databases 208 of the server. The information stored for each user may include whether that device has the smart client 52 installed thereon and information of the user device's technical capabilities, such as the display size. A single user may have multiple devices (described below in more detail in relation to FIG. 11), and information about the multiple devices would be stored on the user profile's database 244 and retrieved with message 4. Next, the content sharing manager 240 interrogates the database 224 of users to retrieve the necessary mobile telephone numbers, email addresses etc. (message 5).

The content sharing manager 240 then passes the request to the messaging manager 202, requesting that it sends the content to each user in the golf community, message 6. The content will be automatically added to a mobile blog (moblog) for that community for viewing and commenting on via the web.

In this example, the preferences for mobile user B, 234, obtained from the profile's database 244 indicates that user B wishes to receive images via MMS. Therefore, the images are transmitted from the messaging manager 202 to the device if user B by MMS (message 7).

The device 236 of fixed user C is not a mobile telecommunications device. The preferences for user C stored in the profiles database 244 indicate that content should be received by email (user C will preferably set the preferences in the profiles database 244 by means of a website interface). The image is then sent from the messaging manager 202 to the device 236 of fixed user C via email (message 9).

The device 246 of a second mobile user E has its preference set in the mobile user's database 244 as receiving images by means of a Java-push download, which causes the image to be automatically displayed on the client application on that device 246. A Java-push download is an SMS-based mechanism that can be used to trigger Java based applications and methods contained within these applications (as defined in the Java 2 Platform—Micro Edition MIDP 2.0 specification for mobile devices) whereby a binary SMS message containing a port number (defined within a particular mobile device application), is sent to the mobile handset, and from there, is passed directly to the Java application Push Registry on the handset. This Push Registry forwards the message to a particular application on the mobile device that has registered the port number specified. (in this example the client application 52). The client application 52 can then decide how to handle information contained within the message. In this example, the message will contain a URL to download the content automatically. In accordance with the preferences of mobile user E in the profiles database 244, the messaging manager 202 sends the image via a Java-push download (message 8).

### Adaptation of Content for Community Members

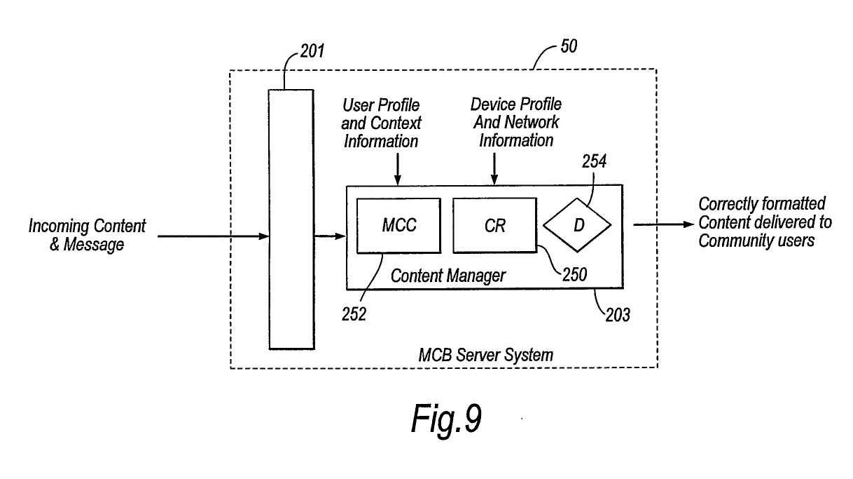

The server 50 advantageously allows intelligent adaptation of content, as will now be described in more detail with reference to FIG. 9. Intelligent content adaptation adapts content to the most appropriate format for the receiving smart client application 52 on each device. Functionality for performing intelligent content adaptation are present on both the smart client 52 and the server 50.

The smart client 52 includes the following features which are built into the media manager component 103 (FIG. 3):
(1) A device manager that determines the content handling capabilities of each device, such as screen resolution, colour depth, camera support etc.
(2) Network manager which is used to test performance of the smart client's network connection (data rate etc.).

The server 50 (shown in FIG. 9) has the following features, which are built into the content manager component 203:
(1) Content resizer 250, which is used to optimise content delivery to community users based on the content handling capabilities of the receiving device.
(2) Message and content converters 252, which allow conversion of content and messages for sending by a number of different delivery mechanisms—for example MMS, email, Java-push download etc.
(3) Decision making logic function 254, which makes a decision as to what method to deliver the content based all the information available about the device and the network connection of that device (these being referred to as intelligent content adaptation (ICA) parameters).

The ICA parameters comprise:
(1) The user preferences stored in the profiles database 244 (FIG. 8).
(2) The context including the user's presence and location.
(3) The network characteristics (for example, bandwidth, delay etc.).
(4) The device profile—for example, a mobile device's capabilities (screen resolution, colour depth, camera support etc.)—stored in the profiles database 244 (FIG. 8).

The user profile and context information—(1) and (2)—above is obtained from the user. The profile information is stored on the profiles database 244. The context information is obtained from the smart client 52, which sends periodic ‘presence updates’ to the server 50. These would be stored in a context database on the server 50 (one of the databases 208—FIG. 4). Methods of sending and storing presence-related context information are known to those skilled in the art, such as those for Instant Messaging e.g. MSN Messenger. The network characteristics—(3)—can be requested in “near real-time” from the receiving smart client (without user intervention) and then stored in a database. The network characteristics will be dynamic and could be determined by running a series of ‘tests’ using known content and timing how long it takes to download—this could be achieved on either the client or server. One way to implement this would be to determine the network characteristics each time the client is loaded and storing these in a ‘Client Connection Properties’ database on the server (one of the databases 208—FIG. 4). Device profile information—(4)—will be static and stored in the profiles database 244 on the server 52.

Referring to FIG. 9, when the image captured by a device, for example as described with reference to FIG. 8, it is transmitted to the server 50, and is received via the servlet client interface 201 (FIG. 4). From there it is passed to the content manager 203, comprising the message and content converter 252, the content resizer 250 and the decision making logic function 254 described above. Content manager 203 receives the user profile and context information, and the network characteristics and device profile information, described above. The content manager 203 then generates the content in a form that is correctly formatted for each user for delivery to each user.

For example, the display quality criteria for each device stored in the profiles database 244 may allow the content manager 203 to tailor the image data that it sends to a device, so that it is optimised. For example, this could mean that, the image when displayed on the device has the best quality (for example, optimised colour depth and resolution) but is not an unnecessary large file that includes image data that would be redundant to the device. This may optimise the quality of the received image, make efficient use of the mobile telecommunication network resources and prevent unnecessary delays in transmission of the image (because no unnecessary data is sent).

### Updating Community Content

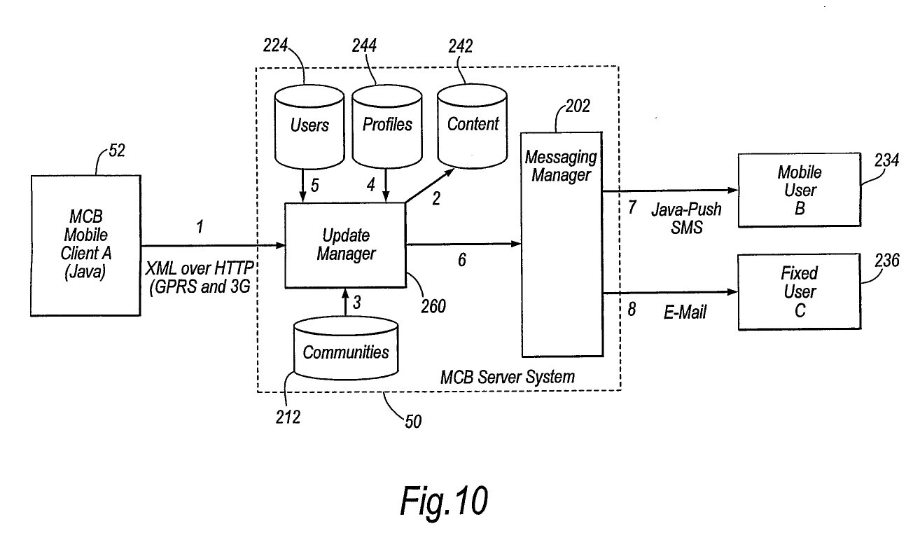

The procedure for updating a community will now be described with reference to FIG. 10. Broadly, the procedure is similar to the procedure described with reference to FIG. 8 for sharing content amongst the community.

By way of example, in FIG. 10 the user of a mobile device wishes to update the golf community with a new “backdrop” image. The image is obtained by the client 52 using the media manager 103 interface with the built-in camera of the mobile device. Client A, 52, of the mobile device transmits a “community update” request to the update manager component of the community management engine 205 of the server 50 using a predetermined XML based schema over HTTP by means of a packet-switched data connection using a GPRS or 3G bearer. The backdrop image is sent to the server 50 via an HTTP post (message 1). The message 1 may contain header information relating to the user ID of the sender and the ID of the relevant community. The update manager 260 adds the new backdrop image to the content database 242 (message 2). The update manager 260 then examines the communities database 212 to retrieve a list of user ID's who are members of the golf community (message 3). The update manager 260 then checks the user profiles database 244 to determine for each user whether that user has the smart client application 52 installed on their device (message 4). The update manager 260 next examines the database 224 of users to retrieve the necessary mobile telephone numbers of the devices in the community, email addresses of the devices in the community etc. (message 5).

The update manager 260 then passes requests to the messaging manager 202 to send the community update to each user in the community (message 6).

In this example user B has a mobile telephone device 234 with the smart client 52 installed thereon. The message manager 202 requests the SMS Gateway 209 (FIG. 4) to send a Java-push SMS message to the smart client 52. The SMS Gateway 209 then sends a series of binary SMS messages to a specific port number (e.g. 5555) corresponding to that of the MCB client. Each SMS message contains a URL of the new image on the server 50 (as well as any other update information). The smart client 52 receives the SMS messages directly (because it is registered to listen on port number 5555) and then passes the messages using a schema that is understood between the client 52 and the server 50. The client 52 then establishes an HTTP connection to the server to download the image and to automatically, by means of a packet-switched data connection using a GPRS or 3G bearer, “skin” the smart client's “golf community page” with the new backdrop (after appropriate confirmation from the user)—message 7.

User C has a fixed PC 236. Therefore, the new backdrop is delivered in an email to the user, informing them that they can use the image as their Windows/Linux etc. wallpaper if they wish.

### Sharing Contact Information

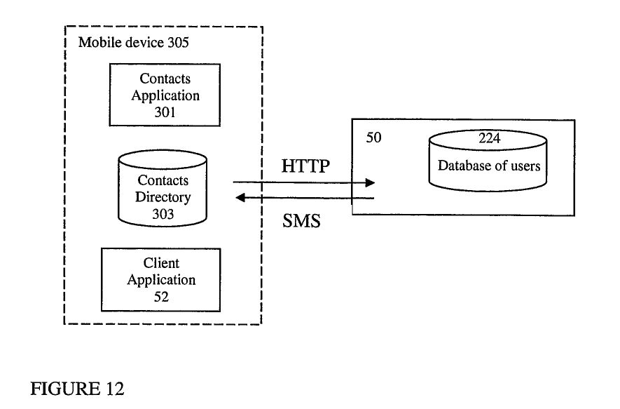

It will now be described with reference to FIG. 12 how community contact information can be maintained and updated in accordance with an embodiment of the present invention. The contact information is stored on the MCB server as a shared list of contacts, and is accessible and updateable by members of a community, referred to from now on as the community address book. Amongst other things, contact information such as the telephone number, email addresses and name of a community member are stored in the community address book. In FIG. 12, the community address book, which contains the contact information of each member of a community, is stored in the database of users 224. In the embodiment shown, the database of users 224 is one of the MCB databases 208 (FIG. 4), which are located on the MCB server 50. Additionally, each member of the community has a phone “contacts” application 301 pre-installed on their mobile terminal 308. The contacts application 301 can be a standard application for storing contact information, as is normally shipped with a mobile terminal and integrated into the terminal's operating system.

The community address book functionality provides means for the members of a community to be notified of a change in the contact information of a member of a community. In FIG. 12, the mobile device includes the client application 52. The client application 52 keeps a locally cached copy of the community address book that is stored on the database of users 224. This locally cached copy is stored in local file storage (memory) on the mobile terminal. When a user updates or changes the information relating to a member of the community stored in his contacts application 301, the client application 52 periodically checks the contact directory information against its locally cached copy stored in the mobile terminal's local file system. If the two entries are different, the client application 52 sends a message to the MCB server 50, informing the MCB server 50 of the updated contact information (this updated information is then updated in the local cache). The message optionally contains a timestamp and codes relating to the identity of the user and the identity of the community. The message is sent over a packet switched connection between the client application 52 and the MCB server 50, for example using a predetermined XML based schema over HTTP. On receipt of the message, the database of users 224 is updated in accordance with the contents of the message.

To inform the other members of the community of the change in contact information, the message manager 202 of the MCB server 50 requests the SMS Gateway 209 (FIG. 4) to send a Java-push SMS message to the client application 52 of each member of the community. The SMS Gateway 209 then sends a series of binary SMS messages to a specific port number (e.g. 5555) of each mobile device. Each SMS message contains a URL of the updated contact information on the server 50. Each client application 52 receives the SMS messages directly (because they are registered to listen on port number 5555) and then parses the messages using a schema that is understood between the client 52 and the server 50. Each client 52 then establishes an HTTP connection to the server to download the updated contact information and to automatically update the contact directory 303 installed on each respective terminal.

### Updating Client Functionality

A similar procedure to that described in relation to FIG. 10 can be used to dynamically update the features and/or functionality of the client 52 for each member of a community. For example, such updates may be displayed on a web page administered by the network operator. A member of the community logs in to the web page using the user ID and a password. The web page includes a list of available updates and an option to update the community with a particular feature. These updates are stored on the server 50. If the member clicks the option to update the community with a particular feature, a “feature update” request message is sent to the management engine 205 of the server 50. The message may contain header information relating to the user ID of the sender and the ID of the relevant community. The update manager 260 adds the new feature to the content database 242. The update manager 260 then examines the communities database to retrieve a list of user ID's who are members of the community. The update manager 260 then checks the user profiles databases 244 to determine for each user whether that user has the smart client application 52 installed on their device. The update manager 260 next examines the database 244 of users to retrieve the necessary mobile telephone numbers of the devices in the community and email addresses of the devices in the community etc.

The update manager 260 then passes requests to the messaging manger 202 to send the new feature to each user in the community. The update is then loaded onto the devices of each member of the community, using the procedure outlined in relation to FIG. 10.

### Support for Multiple User Devices

As explained when briefly describing the profiles database 244 in relation to FIG. 8, it is possible for a user to have more than one device. For example, a user may have a device for personal use and a device for work use. The procedure for a user to add a second device will now be described with reference to FIG. 11. By this procedure, the user's second device obtains the smart client for use thereon.

The user transmits from the second (unregistered) device a message to SMS gateway 209, indicating that they wish to register for a new smart client (message 1) for use with a second device. The registration request is passed to registration servlet 222. This registration request includes the user's telephone number which is determined by the SMS gateway 209. The registration servlet 222 passes the registration request information to the community creation engine 206 (message 2).

The community creation engine 206 modifies the registration for the user in database 224 of users. The database 224 then returns the existing user ID for the user as well as a dynamically assigned client ID which uniquely identifies that user's new smart client (message 3).

The community creation engine 206 then generates a new application descriptor file 226 for the smart client containing various user specific parameters, including the assigned user ID and client ID—message 4. This begins modification of the “unconfigured client” 220 hosted on the server, for use by the second device. The application archive 228 is rebuilt if necessary. The community creation engine 206 then generates a request to send a WAP push message to the second user device containing a URL link to the smart client 202. This message is passed to the SMS gateway 209 via the registration servlet 222 (message 5). The SMS gateway 209 then sends the WAP push message to the second user device (message 6).

When the user activates the URL (for example by clicking using the GUI on the second device), downloading of the smart client is initiated by sending an HTTP GET request, by means of a packet-switched data connection using a GPRS or 3G bearer, containing a UAPROF header (generated from the second device's internal browser) that will contain details of the new device (such as make and model)—message 7. This data can be used to help dynamically configure the client 220 on the server before the client is downloaded. For example, the client will be adapted or optimised for the screen size of the new device. The smart client is then downloaded from the server 50 file system to the second device—message 8.

Any HTTP based access to the server 50 using the (now installed) smart client on the second device will contain the user ID and the client ID parameters in order to uniquely identify both the user and the particular smart client with which they are accessing the server.

A security framework to manage the integrity of content and messages may be provided. For example, content and messages may be encrypted such that they can only be successfully decrypted using a “community key”. Such a community key may be generated by the creator of a community and distributed to its members.

The smart client and server arrangement described allows users to build and manage their own community environment and services within that environment. The communities can be anything from a small group of family and friends, a common interest group (for example, a sports club) or a large ad hoc community such us the attendees of a large music festival.

The smart client and server arrangement allows community environments consisting of a large number of users with different devices (such as different mobile telephone handsets belonging to different mobile operators) to be established. Users within these communities can take on different roles, granting them different powers within that community. Communities can be of a democratic nature, whereby the leadership of the community can be voted on if appropriate. For example, within a community users could have different defined roles, such as creator, leader and ordinary member. The role will determine what powers the user has within the community to make changes—for example, to invite new members.

Users within a community can seamlessly share messages, content and other information between members of the community. The messages, content and other information may be shared amongst all the members of the community or only amongst a subset of the community.

The server system may have a two-way response mechanism to allow community users to automatically reply and comment on messages and content that they have received. This is achieved through the email manager 204 and a direct link to a two-way SMSC interface.

As explained above, it is possible for a user to be a member of the community without having a smart client installed on their device. For example, a user with a fixed PC can participate in a community by means of email communication.

The smart client provides an environment and a graphical user interface (GUI) to manage a user and the membership of a number of distinct mobile communities. Built-in mechanisms that adapt the smart client to support new and updated community information and services through Java-push-download (JPD) or similar push mechanisms may be provided. An integrated alert mechanism may also be provided that is used to display community information, messages and content to users based on the JPD mechanism.

The smart client system allows use of APIs to allow access to underlying device functionality—such as access to the file system in order to allow the user to access and share existing content on their device amongst their communities. Additionally, as mentioned above, the APIs may allow access to a devices content capture mechanisms (such as a built-in camera or microphone) to allow spontaneous and near real-time sharing of content amongst communities.

Further, the APIs may integrate with the device's messaging and call functionality to allow community users to share information directly between each other.

Further, the smart client may provide integrated group and presence management for community groups, so that the members of a group are able to easily view the availability of other members.

Multi-threaded information handling may allow community information updates to be downloaded, and configured in the background without interruption to the user interface.

Integrated interfaces form peripherals such as Bluetooth GPS allowing automatic tagging of location information to client requests may be provided. The smart client may have a modular/component based structure to allow new functionality and services to be introduced as necessary.

EXAMPLE XML Schema
<user>

<id>10</id>
<firstname>Peter</firstname>
<lastname>Thompson</lastname>
<nickname>Pete</nickname>
<role>user</role>
<mobilenumber>+447712345678/mobilenumber>
<presence>online</presence>

</user>
<community>

<id>1</id>
<name>Golf</name>
<description>Golf Community</description>
<type>closed</type>
<theme-url>http://testing123/theme.jpg</theme-url>
<creator>

<user>

<id>10</id>
<firstname>Peter</firstname>
<lastname>Thompson</lastname>
<nickname>Pete</nickname>

<mobilenumber>447712345678</mobilenumber>

<presence>online</presence>

</user>

</creator>
<leaders>

<user>

<id>10</id>
<firstname>Peter</firstname>
<lastname>Thompson</lastname>
<nickname>Pete</nickname>

<mobilenumber>+447712345678</mobilenumber>

<presence>online</presence>

</user>

</leaders>
<members>

<user>

<id>10</id>
<firstname>Peter</firstname>
<lastname>Thompson</lastname>
<nickname>Pete</nickname>

<mobilenumber>+447712345678</mobilenumber>

<presence>online</presence>

</user>
<user>

<id>14</id>
<firstname>Tiger</firstname>
<lastname>Woods</lastname>
<nickname>Tiger</nickname>

<mobilenumber>+447712345679</mobilenumber>

<presence>online</presence>

</user>
<user>

<id>15</id>
<firstname>Colin</firstname>
<lastname>Montgomerie</lastname>
<nickname>Monty</nickname>

<mobilenumber+447712345675/mobilenumber>

<presence>online</presence>

</user>
<user>

</members>

</community>

1. A telecommunications system, including:
a plurality of devices associated in a group; and
a server configured to administer communications between members of the group,
wherein each of said devices is provided with a client application configured to communicate with the server.

2. The system of claim 1, wherein data is uploaded to the client application under control of the server.

3. The system of claim 2, wherein the data is uploaded in response to a trigger message sent from the server.

4. The system of claim 3 wherein the data is uploaded using a binary SMS message sent to the client application.

5. The system of claim 2, wherein the data is one or more of updates to the client application, contact information for users of the group or content for sharing between the devices.

6. The system of claim 5, wherein the server includes means for formatting the content in accordance with parameters associated with each device.

7. The system of claim 6, wherein the parameters include at least one of:
(a) the device user's preferences,
(b) the availability of the device to receive communications of a particular type at a particular time or location,
(c) the characteristics of the communications network by which the server and the client communicate, and
(d) the technical characteristics of the device.

8. The system of claim 7, wherein the technical characteristics of the device comprise the display characteristics of the device.

9. The system of claim 1, wherein the client application is uploaded to the devices under control of the server.

10. The system of claim 1, wherein the server is operable to modify the client application prior to uploading the client application to each device so that the client application includes special functionality relating to the group and/or relating to the technical capabilities of the device.

11. The system of claim 1, wherein messages transmitted between the client device and the server comprise XML over HTTP format.

12. The system of claim 1, wherein the message are transmitted via a wireless data connection.

13. The system of claim 5, wherein the wireless data connection comprises a GPRS or 3G (UTMS) bearer.

14. The system of claim 1, wherein the client application of each device includes an interface with that device's audio and/or video functions.

15. The system of claim 14, wherein the client application is operable to obtain content directly from the audio and/or video functions of the device and to transmit the content to the server to facilitate sharing of the content with the other devices in the group.

16. A method of associating a plurality of communication devices in a group, the method including
providing a server for administering communications between members of the group, and
providing each of the devices with a client application for communicating with the server.

17. The method of claim 16, wherein data is uploaded to the client application under control of the server.

18. The method of claim 17, wherein the data is uploaded in response to a trigger message sent from the server.

19. The method of claim 18, wherein the data is uploaded using a binary SMS message sent to the client application.

20. The method of claim 17, wherein the data is one or more of updates to the client application, contact information for users of the group or content for sharing between the devices.

21. The method of claim 20, wherein the server includes means for formatting the content in accordance with parameters associated with each device.

22. The method of claim 21, wherein the parameters include at least one of:
(a) the device user's preferences,
(b) the availability of the device to receive communications of a particular type at a particular time or location,
(c) the characteristics of the communications network by which the server and the client communicate, and
(d) the technical characteristics of the device.

23. The method of claim 22, wherein the technical characteristics of the device comprise the display characteristics of the device.

24. The method of claim 16, wherein the client application is uploaded to the devices under control of the server.

25. The method of claim 16 wherein the server is operable to modify the client application prior to uploading the client application to each device so that the client application includes special functionality relating to the group and/or relating to the technical capabilities of the device.

26. The method of claim 16, wherein messages transmitted between the client device and the server comprise XML over HTTP format.

27. The method of claim 16, wherein the messages are transmitted via a wireless data connection.

28. The method of claim 20, wherein the wireless data connection comprises a GPRS or 3G (UTMS) bearer.

29. The method of claim 16, wherein the client application of each device includes an interface with that device's audio and/or video functions.

30. The method of claim 16, wherein the client application is operable to obtain content directly from the audio and/or video functions of the device and to transmit the content to the server to facilitate sharing of the content with the other devices in the group.

31. The system of claim 3, wherein the trigger message is a Java and/or SMS trigger.

32. The system of claim 4, wherein the binary SMS message is sent to a predetermined port of the device.
